(19) United States
(12) Patent Application Publication
(10) Pub. No.: US 2015/0113986 A1
(43) Pub. Date: Apr. 30, 2015

(54) COMBINED POWER AND HEAT PUMP SYSTEM USING A COMMON WORKING FLUID

(71) Applicant: Burkhart Technologies, LLC, Strongsville, OH (US)

(72) Inventor: James A. Burkhart, Strongsville, OH (US)

(21) Appl. No.: 14/522,117

(22) Filed: Oct. 23, 2014

Related U.S. Application Data
(60) Provisional application No. 61/895,445, filed on Oct. 25, 2013.

(51) Int. Cl. F24J 3/08; F01K 25/08

(52) U.S. Cl. CPC F24J 3/08; F01K 25/08; F24J 2003/087
USPC 60/641.2; 60/671

(57) ABSTRACT

A thermodynamic system and method for performing work includes a working fluid and a fluid pump for pumping the working fluid through a cycle. A thermal input supplies heat to the working fluid. An expansion device downstream of the thermal input converts at least the heat of the working fluid to useful work. A heat exchanger downstream of the expansion device has a first portion to transfer heat from downstream said expansion device to a second portion at or upstream of said thermal input. A conversion device expands the working fluid with constant enthalpy from a higher to a lower pressure. The conversion device may be part of a heat pump pumping heat from one portion of said working fluid to another portion of the working fluid.

### CROSS REFERENCE TO RELATED APPLICATION

This application claims priority from U.S. provisional patent application Ser. No. 61/895,445, filed on Oct. 25, 2013, the disclosure of which is hereby incorporated herein by reference in its entirety.

### BACKGROUND OF THE INVENTION

The present invention is directed to an ultra-high-efficiency engine system and corresponding thermodynamic system and, in particular, to such a system that uses a common working fluid in both the power production portion and the heat pump portion of the system.

The temperature versus entropy (T vs. S) diagram of FIG. 1 illustrates the low temperature part of the Rankin cycle using the principles of the prior art. Liquid pumping starts at the lowest point of the cycle on the liquid saturation line and is shown by the vertical arrow. The high pressure stream at the left of FIG. 1 flows through heat exchangers to the heat source and power turbine. The heat source and power turbine are not shown. At turbine exit, the stream becomes the low pressure stream. The low pressure stream now traverses the low pressure side of the heat exchangers and is shown on the right in FIG. 1. As this stream reaches the liquid saturation side on the left of the so called “saturation dome,” it must discharge heat to complete the cycle to restart liquid pumping. Heat discharge is represented by the dashed line in FIG. 1.

### SUMMARY OF THE INVENTION

This heat discharge out of the prior art system makes it unfeasible to consider a traditional Rankine cycle for any cryogenic power cycle, since the waste stream is at a cold temperature many hundreds of degrees below ambient. The present invention overcomes such limitations.

A thermodynamic system and method for performing work, according to an aspect of the invention, includes a working fluid and a fluid pump for pumping the working fluid through a cycle. A thermal input supplies heat to the working fluid. An expansion device downstream of the thermal input converts at least the heat of the working fluid to useful work. A heat exchanger downstream of the expansion device has a first portion to transfer heat from downstream said expansion device to a second portion at or upstream of said thermal input. A conversion device expands the working fluid with constant enthalpy from a higher to a lower pressure. The conversion device may be part of a heat pump pumping heat from one portion of the working fluid to another portion of the working fluid.

The invention is directed to a thermodynamic system and method that may find application in the direct extraction of power from earth surface sensible heat, from the heat of geothermal wells, from the latent and sensible heats of surface water and from the heat in ambient air. No other heat or fuel source is required. However, embodiments of the invention may also find application as a power-producing bottoming system for existing and new fossil-fuel-fired and nuclear power plants and for such engines as Diesel and internal combustion.

A greatly simplified combined heat pump/power cycle system, according to aspects of the invention, may be used with helium, neon, or argon as a working fluid because they are very low temperature cryogenic fluids necessary for the combined heat pump/power cycle system to function properly. The other very rare and expensive cryogenic fluids, krypton and xenon, are also feasible, but not needed in most applications. Blended fluids consisting of various ratios of helium, neon, or argon may be used to accommodate the temperature range of the heat source. Organic fluids exist at temperatures slightly below ambient for various refrigeration applications of the past. A variety of low temperature synthetic fluids, many of which are yet to be developed, may be used.

A thermodynamic system and method of producing useful work, according to an aspect of the invention, includes providing a working fluid and a fluid pump for pumping the working fluid through a cycle. A thermal input is provided for supplying heat to the working fluid. An expansion device downstream of the thermal input converts motion of the working fluid to useful work. A unique heat pump, according to an embodiment of the invention, is provided and will be described in greater detail later. The heat pump pumps heat from one portion of the working fluid to another portion of the working fluid.

Commonly assigned U.S. Pat. No. 8,707,701 B2, the disclosure of which is hereby incorporated herein by reference, discloses adding a heat pump loop to a Rankine power cycle as a means of recovering the low grade waste heat resulting in a substantial increase (from 35% to 80%) in power system efficiency and greatly reduces the magnitude of the low grade waste heat. The embodiments disclosed herein use a single working fluid and eliminate the boiling and re-boiling across the “so-called” wet region of the T vs. S curve. It eliminates the need for a large compressor in the heat pump system. This provides more power production that is available for performing work.

Operation is primarily focused within the cryogenic temperature regime, such as helium, but other fluids, such as neon, argon and blends of helium, neon and argon and more exotic cryogenic fluid may be used.

These and other objects, advantages and features of this invention will become apparent upon review of the following specification in conjunction with the drawings.

### BRIEF DESCRIPTION OF THE DRAWINGS

FIG. 1 is a T vs. S diagram of the lower part of a power cycle according to known principles showing with dashed lines where low grade heat must be expelled from the cycle to the outside world;

FIG. 2 is a T vs. S diagram of the lower part of a neon power cycle showing the addition of a heat pump to recover low grade waste heat and subsequently re-insert the heat back into the power cycle;

FIG. 3 is a block diagram of a system, according to an embodiment of the invention, including both a power system and a heat pump system using helium as a working fluid and capable of producing power from ambient temperature sources such as air, water, soil, and geothermal wells;

FIGS. 4A and 4B show the complete T vs. S structure of the system shown in the block diagram of FIG. 3;

FIGS. 5A and 5B show the complete T vs. S structure of a power system that recovers and reuses waste heat with a J-T valve; and

FIG. 6 is a block diagram of the system that carries out the T vs. S structure in FIGS. 5A and 5B.

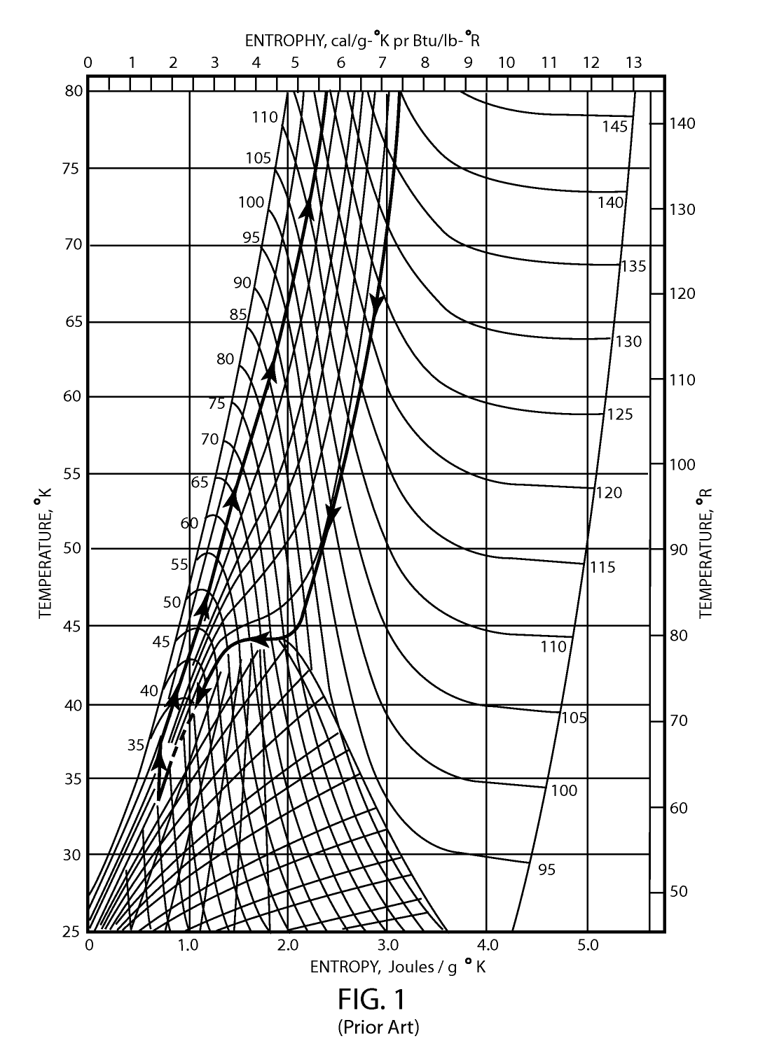

### DESCRIPTION OF THE PREFERRED EMBODIMENTS

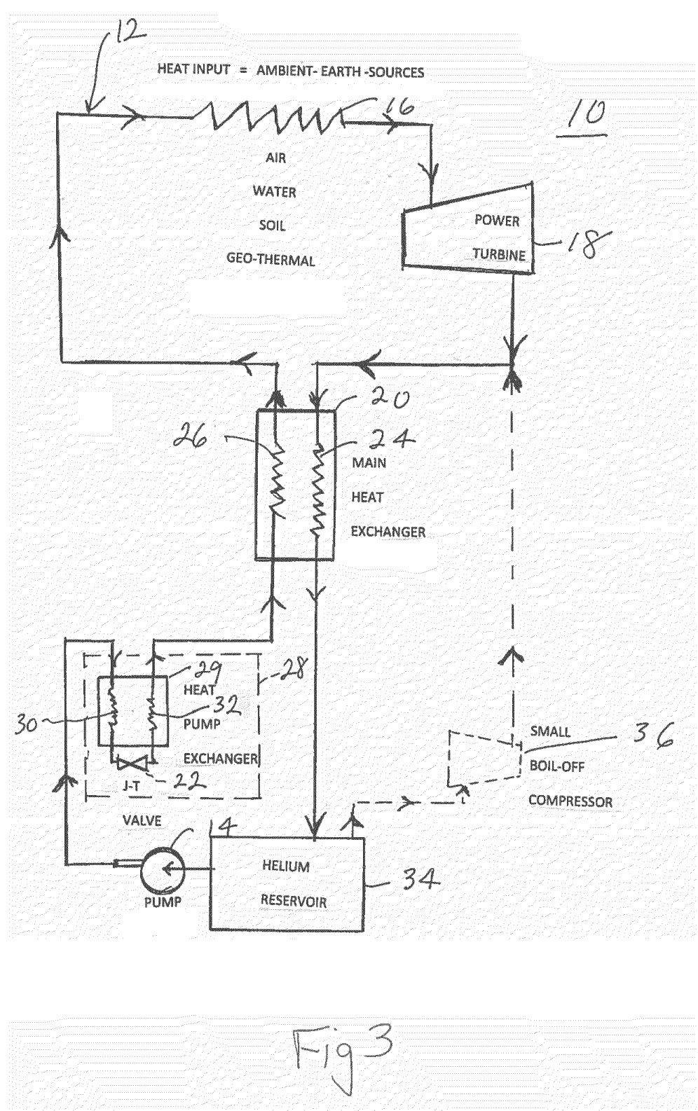

Referring now to the drawings and illustrative embodiments depicted therein a thermodynamic system 10 includes a circuit 12 circulating a working fluid, a fluid pump 14 for pumping the working fluid through a cycle in circuit 12, a thermal input 16 for supplying heat to the working fluid and an expansion device 18 downstream of thermal input 16 for converting at least the heat of the working fluid to useful work (FIG. 3). A heat exchanger 20 downstream of expansion device 18 has a first portion 24 to transfer heat from downstream expansion device 18 to a second portion 26 at or upstream of thermal input 16. In the illustrated embodiment, the expansion device is a liquid turbine. A conversion device 22 is adapted to expand working fluid 12 from a high pressure state to a lower pressure state at constant enthalpy. A reservoir 34 stores the working fluid primarily in a liquid state. An optional boil-off compressor 36 converts any working fluid in a gaseous state in reservoir 34 to a liquid and returns the working fluid downstream of expansion device 18. A heat pump 28 pumps heat from one portion of working fluid in circuit 12 to another portion of the working fluid. Heat pump 28 includes conversion device 22. Heat pump 28 includes a heat exchanger 29 transferring heat from a first heat pump portion 30 to a second heat pump portion 32. Conversion device 22 is connected in circuit 12 between heat pump portions 30 and 32. Heat pump 28 is downstream fluid pump 14 and upstream the second portion 26 of heat transfer device 20. In the illustrated embodiment, conversion device 22 is a J-T valve. However, other devices performing the same function as a J-T valve could be used. Conversion device 22 operates generally isenenthalpally and may also operate generally isentropically.

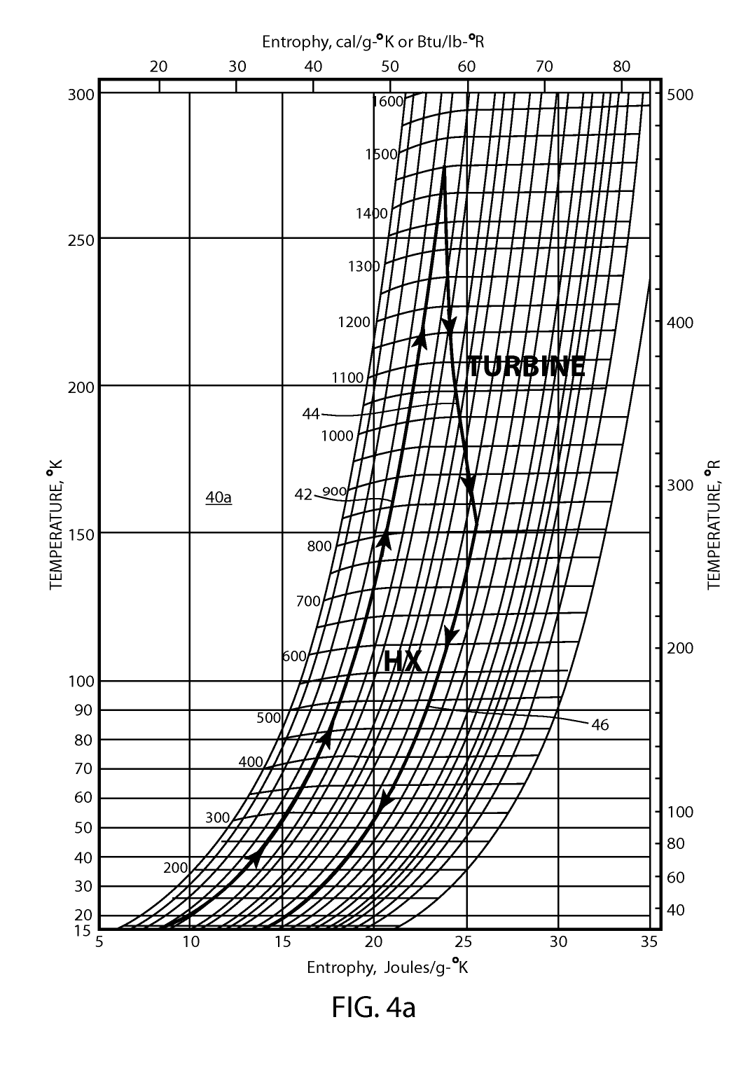

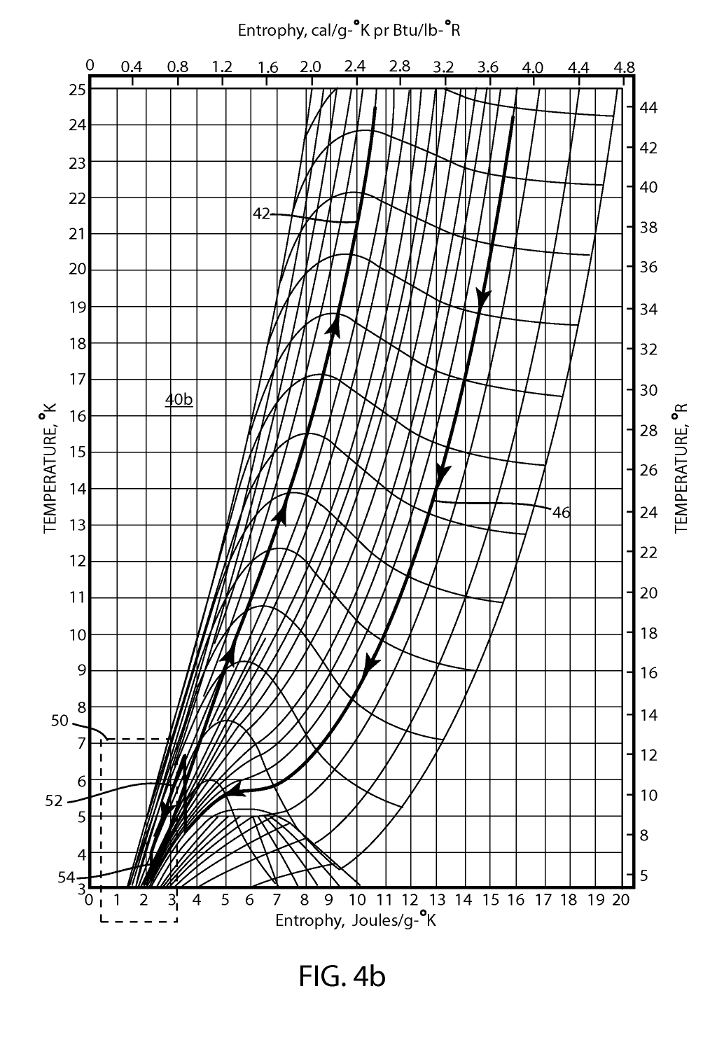

The working fluid in circuit 12 includes a noble gas, such as helium, and has a portion of the working fluid in circuit 12 operating in a cryogenic temperature region. Operation of system 10 with helium as the working fluid is illustrated beginning at FIG. 4a and is a high temperature portion 40a of a temperature versus enthalpy (T vs. S) diagram 40 that has a first portion 42 showing the high pressure curve through heat input 16 and a portion 44 that represents the expansion device 18. A low pressure curve 46 representing the temperature drop from first portion 24 of heat exchanger 20 extends to lower temperature portion 40b of system diagram 40 shown in FIG. 4b. Low pressure curve 46 extends to portion 48 representing liquid pump 14 and a heat pump portion 50. Heat pump portion 50 includes a high pressure portion 52 representing the heat drop in first portion 30 of the heat pump heat exchanger and a portion 54 that represents the constant enthalpy pressure reduction in the conversion device, such as J-T valve 22. From conversion device 22 a low pressure rise 56 represents the heat rise in second portion 32 of heat pump heat exchanger 29 and extends to portion 42 where heat is added by second portion 26 of main heat exchanger 20.

Operation of system 10 is as follows. The cycle begins with the helium reservoir 34 at the extreme bottom of the cycle. The liquid is then pumped to a pressure above the high-operating pressure of the power system (for example, 200 atmospheres) and adds heat of compression to the working fluid. The stream then enters the first portion 30 of heat pump exchanger 29 in a direction opposite the main system flow with respect to heat transfer. The working fluid gives up the heat of compression and then enters a conversion device, such as a J-T valve 22 or, alternatively, a small liquid turbine, which drops the pressure down to the operating pressure (such as 100 atmospheres). Flow then enters the low pressure side of the heat pump heat exchanger 32 to receive heat from heat exchanger 30 and deposit the heat of compression and waste heat back into the system high pressure flow. From there, the high pressure stream (which begins to change from a liquid to a vapor state) enters the second portion 26 of main heat exchanger 20 to exchange heat with first portion 24 receiving the low pressure stream leaving the main power turbine 18. When the high pressure stream leaves the main heat exchanger 26, its temperature is in the low temperature range of negative 200 degrees F. to negative 110 degrees F., substantially below ambient. This very cold stream now enters thermal input 16 which may be a heat exchanger system embedded in one of the earth's near-ambient temperature sources, such as the air, water, soil, or a geo-thermal well. Likewise, this heat exchanger system could be in the waste heat stream of a fossil fuel or nuclear-fired power plant, or in various waste streams of diesel or internal combustion engines. The temperature of the high pressure stream as it exits the thermal input 16 of the heat input heat exchanger could vary from near ambient to 800 degrees F. or 900 degrees F. depending on the exact application and system design. A very large temperature gradient exists across the main heat input heat exchanger.

The high pressure stream now enters the main power turbine or turbine power system 18 to generate power or produce other useful work. Power production results in a substantial reduction in both stream temperature and pressure. From turbine exit, the stream enters the first portion 24 of main heat exchanger 20 and then returns to the helium reservoir 34 primarily as a liquid. The system heat exchangers are designed to prevent boil-off in the steady state. However, in transient upset, or normal dewar boil-off, a small compressor 36, as shown on the lower right, provides sufficient refrigeration to return boil-off gas to liquid.

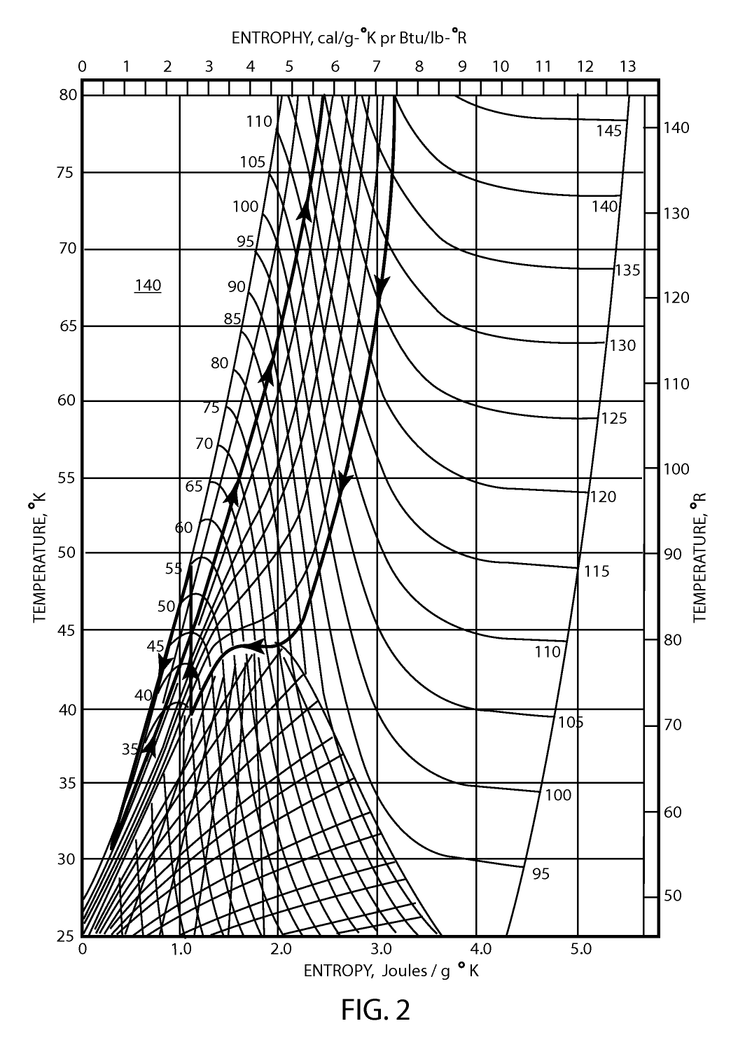

A diagram 140 illustrates operation of system 10 using neon as a working fluid in circuit 12 (FIG. 2). As can be seen from FIG. 2, the shape of curve 140 has the same overall appearance as curve 40b, but different values. Working fluid in circuit 12 may alternatively include argon and even the less common and more expensive noble gases, krypton or xenon. FIG. 2 is a T vs. S schematic showing a heat pump system 10. Instead of dumping heat to the outside world, the heat pump system raises the temperature of the waste heat stream slightly so that it can be re-inserted into the high pressure side of the system. To accomplish this, the low pressure stream of FIG. 2 is immediately compressed, not only to the high pressure of the high pressure stream, but to a pressure slightly above the high pressure. This stream now enters a new heat exchanger wherein the high pressure stream, flowing in a direction opposite to the overall system flow, drops its over-pressure down to the high system pressure by passing through a J-T valve or a small liquid turbine. From there, the stream passes through the low temperature side of this heat pump heat exchanger and flows onto the main system heat exchanger.

System 10 may achieve up to 80% efficiency and is capable of operating on low temperature heat source. As such, thermal input 16 may receive earth surface sensible heat, (i) geothermal heat from a geothermal well, (ii) latent heat of surface water, (iii) sensible heat of surface water, or (iv) heat from ambient air. However, heat input 16 may be used as a power-producing bottoming system for an existing or new fossil-fuel-fired power plant or for an existing or new nuclear power plant. Heat input 16 may be used as a power-producing bottoming-cycle for an existing or new diesel engine and an existing or new internal combustion engine. Other applications will be apparent to the skilled artisan and as set forth in my earlier U.S. Pat. No. 8,707,701 B2, issued Apr. 29, 2014, the disclosure of which is hereby incorporated herein by reference.

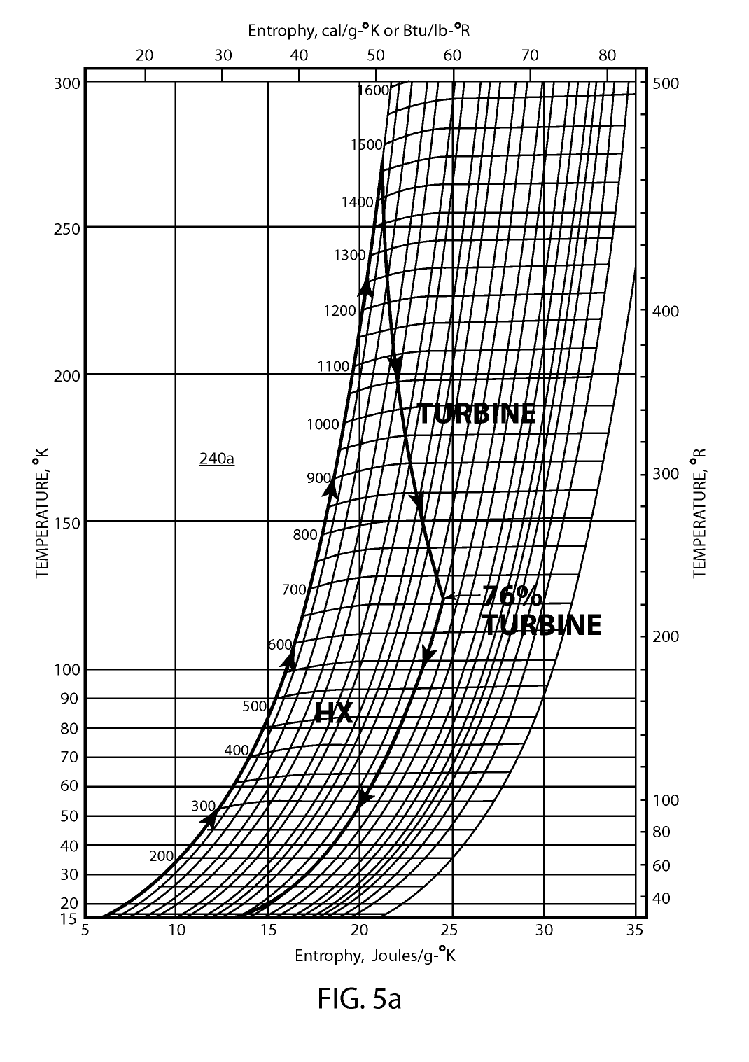

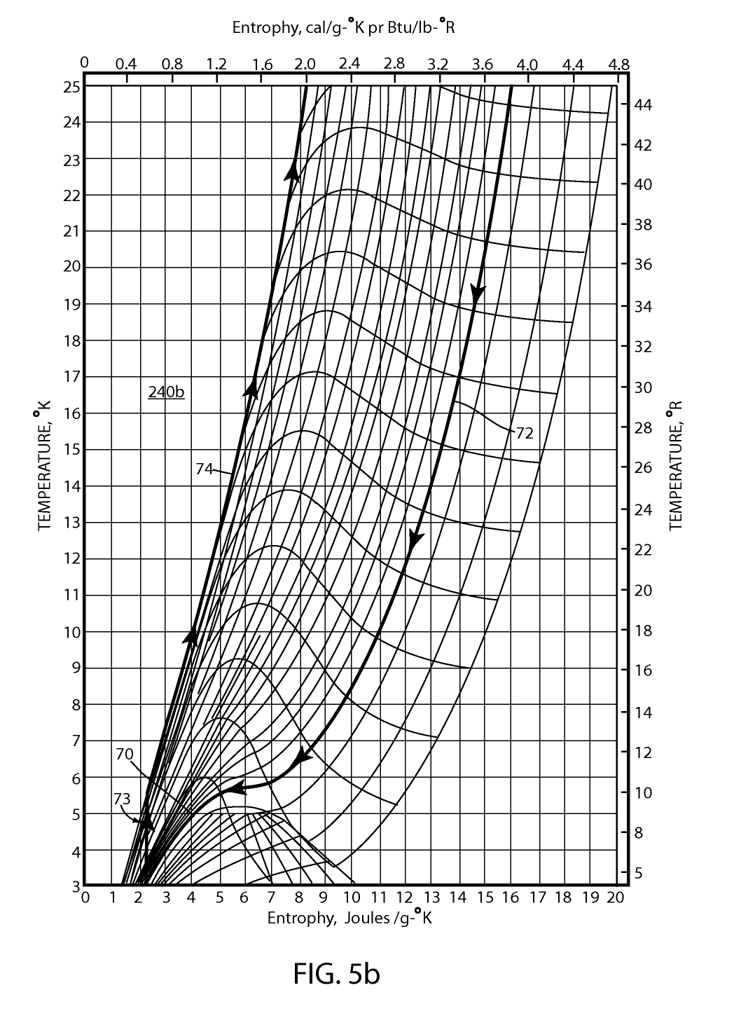

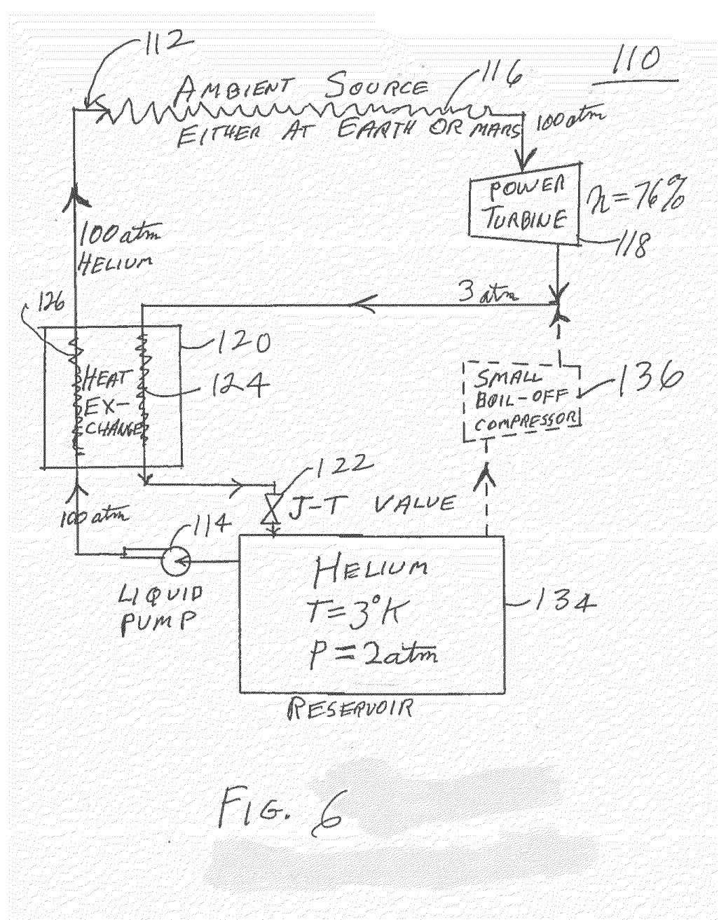

A thermodynamic system 110 that operates without a heat pump, per se, includes a working fluid in a circuit 112 including a thermal input 116 and an expansion device, such as a gaseous power turbine 118 (FIG. 6). A heat exchanger 120 has a first portion 124 that transfers heat from the fluid discharged by expansion device 118 to a second portion 126 supplying fluid at or upstream of thermal input 116. A conversion device, such as a J-T valve 122, converts the working fluid in a gaseous state to a liquid state by expanding the fluid from a high to a low pressure state at constant enthalpy. The liquid working fluid is deposited in a reservoir 134 and an optional small compressor 136 compresses any working fluid in reservoir 134 to a liquid state and returns the working fluid to circuit 112. Liquid pump 114 raises the pressure of the working fluid which is sent to second portion 126 of heat exchanger 120. FIGS. 5A and 5B illustrate the T vs. S diagrams for the high pressure helium cycle carried out by system 110 where a single J-T valve 122 provides a similar function to that of heat pump 28 in system 10. A thermal cycle 240a and 240b shown in FIGS. 5a and 5b includes a constant enthalpy curve 70 provided by J-T valve 122 that receives the working fluid in a gaseous phase at 72 and supplies liquid working fluid to fluid pump 124 that pumps the fluid at 73 through the second portion 126 of heat exchanger 122 at curve 74. Except as set forth, operation of the thermodynamic system is generally the same as system 10 and thermal cycle 240a, 240b is generally the same as cycles 40a, 40b and 140a. Working fluid in circuit 112 can be any of the noble gases previously described with respect to the working fluid in circuit 12. Also, thermal input 116 can be any of those described with respect to thermal input 16.

Thus, it can be seen that the invention as illustrated in the embodiments herein reduces the amount of boiling and re-boiling to as close to zero as possible and does so in a manner that reduces the number of components in the overall system. Also, the system uses one working fluid, not two. As many components as possible are eliminated.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A thermodynamic system, comprising:
a working fluid;
a fluid pump for pumping the working fluid through a cycle;
a thermal input for supplying heat to the working fluid;
an expansion device downstream of the thermal input for converting at least the heat of the working fluid to useful work;
a heat exchanger downstream of said expansion device having a first portion to transfer heat from downstream said expansion device to a second portion at or upstream of said thermal input; and
a conversion device that is adapted to expand the working fluid with constant enthalpy from a higher to a lower pressure.

2. The thermodynamic system as claimed in claim 1 wherein said conversion device is downstream said first portion of said heat exchanger.

3. The thermodynamic system as claimed in claim 2 wherein said liquid pump is downstream said conversion device and upstream said second portion of said heat exchanger.

4. The thermodynamic system as claimed in claim 1 wherein said conversion device comprises a J-T valve.

5. The thermodynamic system as claimed in claim 1 wherein said expansion device comprises a power turbine.

6. The thermodynamic system as claimed in claim 1 wherein said conversion device operates at least one chosen from generally isentropically and generally isenenthalpally.

7. The thermodynamic system as claimed in claim 1 wherein a portion of the cycle is in a cryogenic temperature region.

8. The thermodynamic system as claimed in claim 7 wherein said working fluid is at least one noble gas.

9. The thermodynamic system as claimed in claim 7 wherein said working fluid comprises at least one chosen from helium, neon and argon.

10. The thermodynamic system as claimed in claim 7 wherein said working fluid comprises krypton or xenon.

11. The thermodynamic system as claimed in claim 1 wherein said thermal input is configured to receive at least one chosen from (i) earth surface sensible heat, (ii) geothermal heat from a geothermal well, (iii) latent heat of surface water, (iv) sensible heat of surface water; and (v) heat from ambient air.

12. The thermodynamic system as claimed in claim 1 adapted for use as a power-producing bottoming system for at least one chosen from (i) an existing or new fossil-fuel-fired power plant; (ii) an existing or new nuclear power plant; (iii) an existing or new diesel engine and (iv) an existing or new internal combustion engine.

13. A thermodynamic system, comprising:
a working fluid;
a fluid pump for pumping the working fluid through a cycle;
a thermal input for supplying heat to the working fluid;
an expansion device downstream of the thermal input for converting at least the heat of the working fluid to useful work;
a heat exchanger downstream of said expansion device having a first portion transferring heat from downstream said expansion device to a second portion at or upstream of said thermal input; and
a heat pump, said heat pump pumping heat from one portion of said working fluid to another portion of the working fluid, said heat pump including a conversion device that is adapted to expand the working fluid from a high to lower pressure state at constant enthalpy.

14. The thermodynamic system as claimed in claim 13 wherein said heat pump comprises a heat pump heat exchanger transferring heat from a first heat pump portion to a second heat pump portion, said conversion device being connected between said heat pump portions.

15. The thermodynamic system as claimed in claim 14 wherein said heat pump is downstream the fluid pump and upstream the second portion of said second portion of said heat transfer device.

16. The thermodynamic system as claimed in claim 13 wherein said heat pump is downstream the fluid pump and upstream the second portion of said second portion of said heat transfer device.

17. The thermodynamic system as claimed in claim 13 wherein said conversion device operates generally isentropically or isenenthalpally or a combination thereof.

18. The thermodynamic system as claimed in claim 13 wherein a portion of the cycle is in a cryogenic temperature region.

19. The thermodynamic system as claimed in claim 13 wherein said working fluid is at least one noble gas.

20. The thermodynamic system as claimed in claim 19 wherein said working fluid comprises at least one chosen from helium, neon and argon.

21. The thermodynamic system as claimed in claim 19 wherein said working fluid comprises krypton or xenon.

22. The thermodynamic system as claimed in claim 13 wherein said thermal input is configured to receive at least one chosen from (i) earth surface sensible heat, (ii) geothermal heat from a geothermal well, (iii) latent heat of surface water, (iv) sensible heat of surface water; and (v) heat from ambient air.

23. The thermodynamic system as claimed in claim 13 adapted for use as a power-producing bottoming system for at least one chosen from (i) an existing or new fossil-fuel-fired power plant, (ii) an existing or new nuclear power plant, (iii) an existing or new diesel engine and (iv) an existing or new internal combustion engine.

24. The thermodynamic system as claimed in claim 13 wherein said conversion device comprises a J-T valve.

25. The thermodynamic system as claimed in claim 13 wherein said expansion device comprises a power turbine.

26. A thermodynamic method for performing work, comprising:
a working fluid;
pumping a working fluid with a fluid pump through a cycle;
supplying heat to the working fluid with a thermal input;
converting at least the heat of the working fluid to work with an expansion device downstream of the thermal input;
exchanging heat from downstream of the expansion device to at or upstream of thermal input; and
expand the working fluid with constant enthalpy from a higher to a lower pressure.
